(19) United States
(12) Patent Application Publication
(10) Pub. No.: US 2026/0320114 A1
(43) Pub. Date: Oct. 15, 2026

(54) OBJECT DETECTION DEVICE, OBJECT DETECTION METHOD, AND STORAGE MEDIUM

(71) Applicant: HONDA MOTOR CO., LTD., Tokyo (JP)

(72) Inventors: Riku Inoue, Wako-shi (JP); Masamitsu Tsuchiya, Wako-shi (JP)

(21) Appl. No.: 19/531,716

(22) Filed: Feb. 6, 2026

(30) Foreign Application Priority Data
Feb. 10, 2025 (JP) 2025-019858

(51) Int. Cl. G06F 16/56; G06V 10/22

(52) U.S. Cl. CPC G06F 16/56; G06V 10/22

(57) ABSTRACT

An object detection device includes a storage medium configured to store computer-readable instructions and a processor connected to the storage medium. The processor causes the computer-readable instructions to perform: converting an input image to a high-dimensional vector; determining whether a query set in the input image is an object on the basis of the high-dimensional vector; detecting an area of the object on the basis of the high-dimensional vector; detecting a type of the object on the basis of the high-dimensional vector; and detecting an object by processing the high-dimensional vector. The query includes a first query selected from a plurality of the high-dimensional vectors and an initialized second query. The processor detects the object by processing the high-dimensional vector on the basis of the first query and the second query.

### CROSS-REFERENCE TO RELATED APPLICATION

This application is based upon and claims the benefit of priority from Japanese Patent Application No. 2025-019858, filed Feb. 10, 2025, the entire contents of which is incorporated herein by reference.

### BACKGROUND

### Field of the Invention

The present invention relates to an object detection device, an object detection method, and a storage medium.

### Description of Related Art

Recently, countermeasures for providing access to a sustainable transportation system in which vulnerable persons out of traffic participants are also considered have been actively studied. In order to realize such countermeasures, focus has been concentrated on research and development for further improving safety or convenience of traffic through research and development on automated driving technology or preventive safety technology.

In automated driving technology or preventive safety technology, open world object detection (OWOD) capable of detecting an unknown object in addition to a known object from an image has been studied in the related art. For example, in Orr Zohar, Kuan-Chieh Wang, and Serena Yeung. Prob: Probabilistic objectness for open world object detection, in Proceedings of the IEEE/CVF Conference on Computer Vision and Pattern Recognition, pages 11444-11453, 2023 (Non Patent Document 1), a technique of detecting whether an unknown object is probabilistically an object without using a pseudo-label for the unknown object is described. In Zhuyu Yao, Jiangbo Ai, Boxun Li, and Chi Zhang, Efficient detr: improving end-to-end object detector with dense prior, arXiv preprint arXiv: 2104.01318, 2021 (Non Patent Document 2), a technique of detecting an object by converting an image to a feature map using a convolutional neural network (CNN) and applying a transformer to the feature map is described.

More specifically, the technique described in Non Patent Document 1 causes a decoder of the transformer to simultaneously learn objectness (whether it is an object) estimation and class estimation. The technique described in Non Patent Document 2 inputs object queries for object detection and class classification to a decoder of a transformer and causes the decoder to learn the object queries at the time of learning.

However, in the technique described in Non Patent Document 1, learning of objectness estimation and learning of class estimation competes. In the technique described in Non Patent Document 2, the object queries are not configured to ascertain features of an object in an initial layer of the decoder, and thus there is room for improvement in accuracy of object detection in the related art.

### SUMMARY OF THE INVENTION

The present invention was made in consideration of the aforementioned circumstance, and an objective thereof is to provide an object detection device, an object detection method, and a storage medium that can improve object detection accuracy by enabling ascertaining features of an object from an initial layer of a decoder of a transformer while preventing competition between learning of objectness estimation and learning of class estimation in object detection for both a known object and an unknown object. Another objective is to contribute to development of a sustainable transportation system.

An object detection device, an object detection method, and a storage medium according to the present invention employ the following configurations.
(1) According to an aspect of the present invention, there is provided an object detection device including: a storage medium configured to store computer-readable instructions; and a processor connected to the storage medium, wherein the processor executes the computer-readable instructions to perform: converting an input image to a high-dimensional vector; determining whether a query set in the input image is an object on the basis of the high-dimensional vector; detecting an area of the object on the basis of the high-dimensional vector; detecting a type of the object on the basis of the high-dimensional vector; and detecting an object by processing the high-dimensional vector, wherein the query includes a first query selected from a plurality of the high-dimensional vectors and an initialized second query, and wherein the processor detects the object by processing the high-dimensional vector on the basis of the first query and the second query.
(2) In the aspect of (1), the first query is selected to be distributed to known objects in the input image, and the second query is set to be distributed to the whole input image and is learned to be distributed to known objects and unknown objects.
(3) In the aspect of (1), the processor detects the object on the basis of the detection results of the area and the type based on the high-dimensional vector obtained by processing the high-dimensional vector a plurality of times and the determination results based on the high-dimensional vector obtained by processing the high-dimensional vectors before the plurality of times.
(4) In the aspect of (1), functional units for the conversion of the high-dimensional vector, the determination, the detection of the area, and the detection of the type are obtained by training a deep learning model including a self-attention mechanism.
(5) In the aspect of (4), the deep learning model is a transformer model, and the processor detects an object on the basis of the detection results of the area and the type based on the high-dimensional vector obtained by processing the high-dimensional vector a plurality of times in layers of a decoder of the transformer model and the determination results based on the high-dimensional vector obtained by processing the high-dimensional vector before the plurality of times in the layers of the decoder.
(6) In the aspect of (1), 6 the processor calculates whether the query is an object as a first probability value, the processor calculates the type of the query as a second probability value, and the processor detects an object on the basis of the first probability value and the second probability value.
(7) According to another aspect of the present invention, there is provided an object detection method that is performed by a computer, the object detection method including: converting an input image to a high-dimensional vector; determining whether a query set in the input image is an object on the basis of the high-dimensional vector; detecting an area of the object on the basis of the high-dimensional vector; detecting a type of the object on the basis of the high-dimensional vector; and detecting an object by processing the high-dimensional vector, wherein the query includes a first query selected from a plurality of the high-dimensional vectors and an initialized second query, and wherein the object is detected by processing the high-dimensional vector on the basis of the first query and the second query.
(8) According to another aspect of the present invention, there is provided a non-transitory computer-readable storage medium storing a program causing a computer to perform: converting an input image to a high-dimensional vector; determining whether a query set in the input image is an object on the basis of the high-dimensional vector; detecting an area of the object on the basis of the high-dimensional vector; detecting a type of the object on the basis of the high-dimensional vector; and detecting an object by processing the high-dimensional vector, wherein the query includes a first query selected from a plurality of the high-dimensional vectors and an initialized second query, and wherein the object is detected by processing the high-dimensional vector on the basis of the first query and the second query.

According to the aspects of (1) to (8), it is possible to improve object detection accuracy by enabling ascertaining features of an object from an initial layer of a decoder of a transformer while preventing competition between learning of objectness estimation and learning of class estimation in object detection for both a known object and an unknown object. It is possible to contribute to development of a sustainable transportation system.

### BRIEF DESCRIPTION OF THE DRAWINGS

FIG. 1 is a diagram illustrating an example of a system including an object detection device according to an embodiment of the present invention.

FIG. 2 is a diagram illustrating an example of a configuration of training data.

FIG. 3 is a diagram illustrating an example of a configuration of a machine learning model in a learning step.

FIG. 4 is a diagram illustrating object queries generated by a query generating unit.

FIG. 5 is a diagram illustrating processes performed by a decoder unit.

FIG. 6 is a diagram illustrating an example of a configuration of a machine learning model in an inference step.

FIG. 7 is a diagram illustrating advantageous effects of the technique according to the present invention.

FIG. 8 is a flowchart illustrating an example of a process flow of learning of a machine learning model.

FIG. 9 is a flowchart illustrating an example of a process flow of inference of a machine learning model.

### DESCRIPTION OF EMBODIMENTS

Hereinafter, an object detection device, an object detection method, and a program according to an embodiment of the present invention will be described with reference to the accompanying drawings.

### [Entire Configuration]

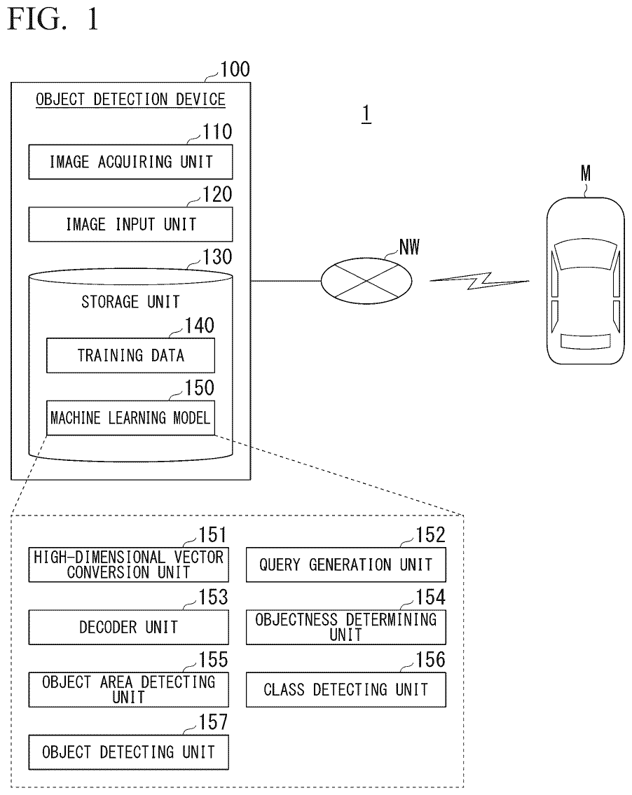

FIG. 1 is a diagram illustrating an example of a system 1 including an object detection device 100 according to an embodiment of the present invention. As illustrated in FIG. 1, the system 1 includes a vehicle M and an object detection device 100. In FIG. 1, for example, the vehicle M and the object detection device 100 are illustrated as separate bodies, but the object detection device 100 may be mounted in the vehicle M. Linkage of the object detection device 100 and the vehicle M is merely exemplary, and the object detection device 100 may be used independently without linking with the vehicle M. For example, the object detection device 100 may be mounted as a web server or may be mounted as an application program in a terminal device (for example, a personal computer or a smartphone) of a user.

The vehicle M is, for example, a hybrid vehicle or an electric vehicle and includes, for example, a camera that images the outside of the vehicle M. The vehicle M transmits an outside image captured by the camera while traveling to the object detection device 100 via a network NW such as a cellular network, a Wi-Fi network, or the Internet.

The object detection device 100 receives an image transmitted from the vehicle M and detects an object appearing in the received image. The object detection device 100 includes, for example, an image acquiring unit 110, an image input unit 120, and a storage unit 130. The constituents of the image acquiring unit 110, the image input unit 120, or the like are realized, for example, by causing a hardware processor (a computer) such as a central processing unit (CPU) to execute a program (software). Some or all of these constituents may be realized by hardware (a circuit part including circuitry) such as a large scale integration (LSI) device, an application-specific integrated circuit (ASIC), or a field-programmable gate array (FPGA), or a graphics processing unit (GPU or may be cooperatively realized by software and hardware. The program may be stored in a storage device (a storage device including a non-transitory storage medium) such as a hard disk drive (HDD) or a flash memory in advance, or may be stored in a removable storage medium (a non-transitory storage medium) such as a DVD or a CD-ROM and installed by setting the removable storage medium into a drive device.

The storage unit 130 is, for example, an HDD, a flash memory, or a random access memory (RAM). The storage unit 130 stores, for example, training data 140 and a machine learning model 150. For the purpose of convenience of explanation, the storage unit 130 stores the training data 140, but the present invention is not limited to such a configuration, and only the machine learning model 150 trained on the basis of the training data 140 may be stored as will be described later.

The image acquiring unit 110 acquires an image from the vehicle M via the network NW, and the image input unit 120 detects an object appearing in the acquired image by inputting the acquired image to the trained machine learning model 150. The object detection device 100 may transmit information on the detected object to the vehicle M via the network NW. Thereafter, the vehicle M may provide an occupant of the vehicle M with driving support (for example, displaying the detected object on a navigation device of the vehicle M or outputting alert information by audio) on the basis of the information on the detected object or perform automated driving (for example, generating a target trajectory such that the vehicle M avoid the detected object). The object detection device 100 may have such a driving support function or an automated driving function together.

The machine learning model 150 includes, for example, a high-dimensional vector conversion unit 151, a query generating unit 152, a decoder unit 153, an objectness determining unit 154, an object area detecting unit 155, a class detecting unit 156, and an object detecting unit 157 as functional units thereof. These functional units are also realized, for example, by causing a hardware processor such as a CPU to execute a program. In the present embodiment, the machine learning model 150 is obtained by applying two improvements to an object detection technique (more specifically, end-to-end object detection with transformers (DETR)) using a transformer model, and details thereof will be described later.

### [Training Data]

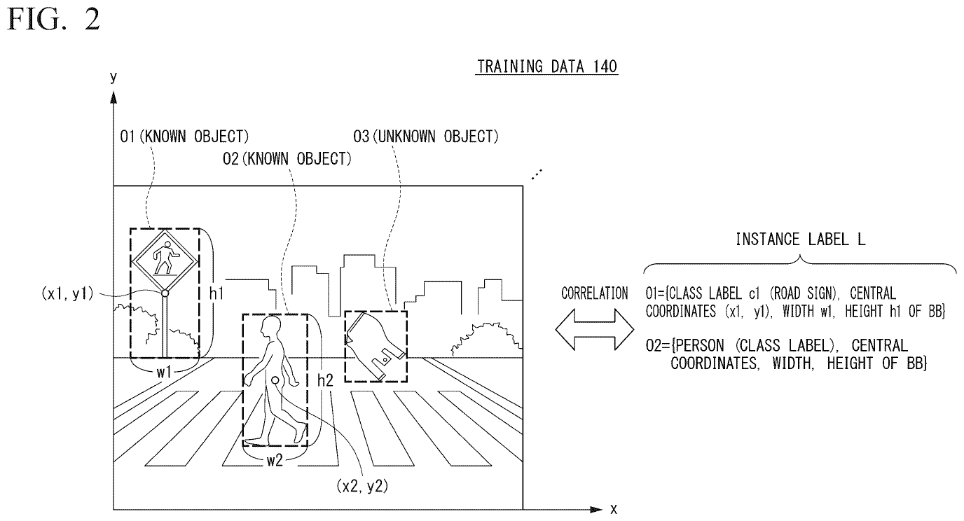

FIG. 2 is a diagram illustrating an example of a configuration of the training data 140. The training data 140 is a data set including a plurality of images IM including both a known object and an unknown object to be detected. For example, in FIG. 2, the images IM include a known object O1 which is a road sign, a known object O2 which is a person, and an unknown object O3 which is a plastic bag. In the present embodiment, a known object is correlated with a class label c indicating the object and central coordinates (x, y), a width w, and a height h of a bounding box (hereinafter simply referred to as BB) surrounding the object in advance. In another aspect, since the bounding box may be expressed by a combination of a minimum value x_min and a maximum value x_max of x coordinates and a minimum value y_min and a maximum value y_max of y coordinates, a known object may be correlated with (x_min, x_max, y_min, y_max).

Accordingly, in the image IM illustrated in FIG. 2, the known object O1 is correlated with a class label c1 indicating a road sign and the central coordinates (x1, y1) and the width w1, and the height h1 of the BB, and the known object O2 is correlated with a class label c2 indicating a person and the central coordinates (x2, y2), the width w2, and the height h2 of the BB. The image IM and combinations of the class labels c and the central coordinates (x, y), the widths w, and the heights h (hereinafter referred to as instance labels c) of the BBs correlated with the known objects included in the images IM constitute the training data 140.

### [Learning of Machine Learning Model]

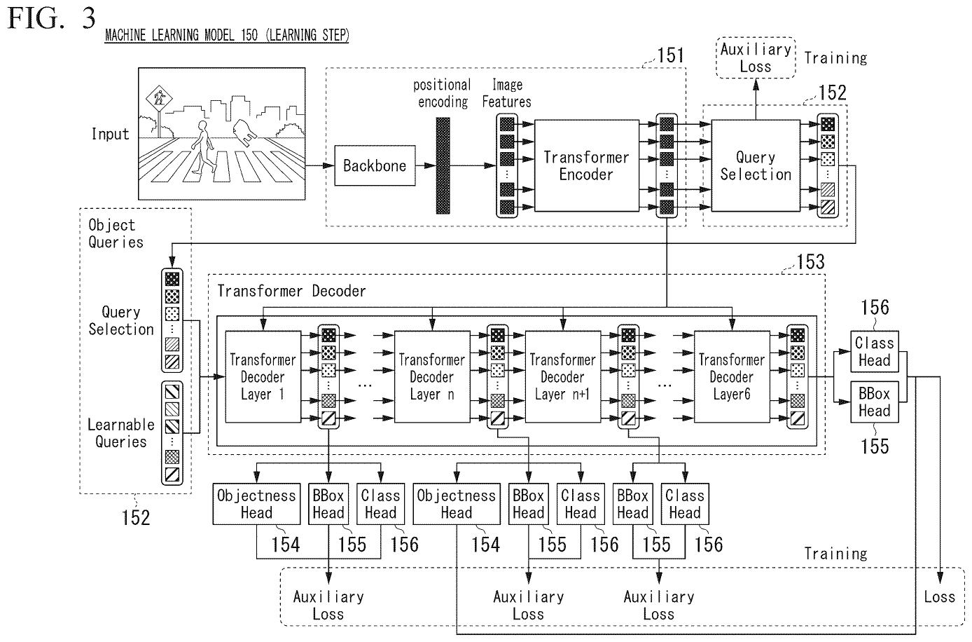

FIG. 3 is a diagram illustrating an example of a configuration of the machine learning model 150 in the learning step. Learning of the machine learning model 150 will be described below with reference to FIG. 3. First, as illustrated in the upper-left part of FIG. 3, the high-dimensional vector conversion unit 151 input the images IM included in the training data 140 to a backbone network. The backbone network includes a convolutional neural network (CNN) and functions to perform a convolutional operation on the input images IM using the CNN and to convert the input images IM to a d-dimensional feature map (a feature quantity) reduced in the number of dimensions.

Then, the high-dimensional vector conversion unit 151 performs positional encoding on the feature map output from the backbone network. Here, the positional encoding is a process of correlating the feature map with the position of the original input image IM. By performing the positional encoding, an object query which will be described later can identify a position on the input image IM from the feature map.

Then, the high-dimensional vector conversion unit 151 inputs the feature map on which the positional encoding has been performed to a transformer encoder. Here, the transformer encoder outputs a plurality of queries (hereinafter referred to as an intermediate object features) from the feature map output from the CNN using a self-attention mechanism and a feedforward layer. Here, a query is a vector (a high-dimensional vector) indicating a part to which attention is to be paid (what is an object) in the image IM. The processes from inputting to the backbone network to outputting from the transformer encoder in the machine learning model 150 are processed that are performed by the high-dimensional vector conversion unit 151.

Then, the query generating unit 152 performs query selection on the queries output from the transformer encoder. Here, the query selection is a process of selecting a query with high accuracy indicating an object in the image IM. As described above, the training data 140 includes instance labels L for known objects, and thus it is possible to select a query paying attention to a known object in the image IM by learning the query selection using the training data 140 on the known objects. More specifically, the query selection is mounted by learning parameters of a deep neural network (DNN) model expressing the query selection for each piece of data of the known objects. Learning of the query selection is performed at the same time as learning of the objectness determining unit 154, the object area detecting unit 155, and the class detecting unit 156 which will be described later.

The query generating unit 152 generates an initialized learnable query. The learnable query is a query that is mainly set to extract an unknown object from the image IM. The query generating unit 152 generates a query selected through the query selection and the initialized learnable query together as object queries. That is, in the technique described in Non Patent Document 2, the object query is not configured to ascertain features of an object in the initial layer of the decoder, and the object query according to the present embodiment includes a query selected through the query selection and paying attention to a known object, and thus is configured to ascertain features of an object from the initial layer of the decoder which will be described below.

The object query generated by the query generating unit 152 is input to a transformer decoder by the decoder unit 153. Here, the transformer decoder functions to multiply the intermediate object features by the object query using a self-attention mechanism, a multi-head attention mechanism, and a feedforward layer and to finally detect an object. In the following description, for the purpose of convenience, it is assumed that the number of object queries is N. N is a hyper parameter which is set in advance.

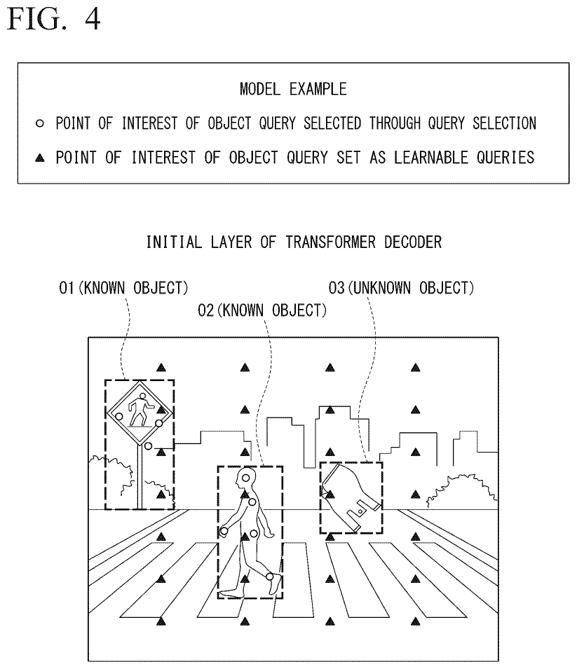

FIG. 4 is a diagram illustrating object queries generated by the query generating unit 152. FIG. 4 illustrates object queries generated by the query generating unit 152 at a time point at which the object queries are input to an initial layer of the transformer decoder. In FIG. 4, an object query indicated by black circles indicates a query which is selected through the query selection, and an object query indicated by black triangles indicates an initialized learnable query.

As illustrated in FIG. 4, queries selected through the query selection tend to be distributed (attention is paid) to known objects (that is, an object O1 and an object O2) in the image IMG at a time point of the initial layer in which the queries are input to the transformer decoder, and the initialized learnable queries are set to be distributed (attention is paid) to the whole image IM regardless of whether the objects are known or unknown in the image IM. In FIG. 4, the initialized learnable queries are set at constant intervals in the image IM, but the present invention is not limited to such a configuration and the initialized learnable queries have only to be initialized using an arbitrary method such as being randomly set.

The decoder unit 153 inputs the object queries generated by the query generating unit 152 to the transformer decoder including a plurality of transformer decoder layers. The initial layer of the transformer decoder receives an input of intermediate object features output from the transformer encoder and N object queries generated by the query generating unit 152, multiplies them using a cross attention mechanism, and outputs N object queries for more precisely ascertaining objects (regardless of whether they are known or unknown) in the image IM.

Similarly, a subsequent layer of the transformer decoder receives an input of intermediate object features output from the transformer encoder and N object queries output from the previous layer of the transformer decoder, multiplies them using a cross attention mechanism, and outputs N object queries for more precisely ascertaining objects (regardless of whether they are known or unknown) in the image IM. By repeating this process, the decoder unit 153 finally outputs N object queries from the final layer of the transformer decoder.

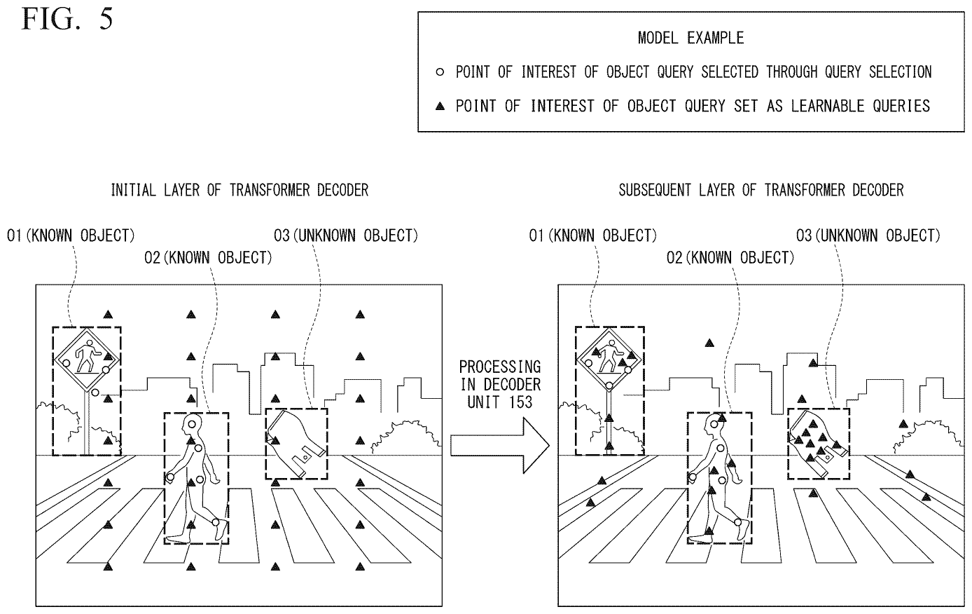

FIG. 5 is a diagram illustrating the process that is performed by the decoder unit 153. The left part of FIG. 5 illustrates the same screen as in FIG. 4, and the right part of FIG. 5 illustrates object queries acquired after the processes (that is, the processes in the transformer decoder layers) have been performed by the decoder unit 153. As illustrated in FIG. 5, objects of the initialized learnable queries are not ascertained in the initial layer, and both the known objects (that is, the object O1 and the object O2) and the unknown object (that is, the object O3) are ascertained as a result of processing of the decoder unit 153. In this way, according to the present embodiment, the object queries include the queries selected through query selection and the initialized learnable queries, and it is possible to ascertain known objects from the initial layer and to ascertain both a known object and an unknown object in a subsequent layer through processing of the decoder unit 153.

The objectness determining unit 154 (objectness head) probabilistically determines whether an object query is an object (objectness) for each object query output from the transformer decoder layer (in the following description, an output value from the objectness determining unit 154 may be referred to as p(o|q)). More specifically, in the present embodiment, a probability value p(o|q) is modeled as a multivariable Gaussian distribution in a query-embedded space, and the objectness determining unit 154 calculates a probability value p(o|q)=f_{obj}(q) on the basis of Expression (1) using a Mahalanobis distance.

f_{obj}(q)=exp(−(q−μ)^{T}Σ⁻¹(q−μ))=exp(d_{M}(q)²) (1)

In Expression (1), reference sign u indicates an average value of the multivariable Gaussian distribution, reference sign 2 indicates a variance-covariance matrix of the multivariable Gaussian distribution, reference sign q indicates a d-dimensional vector which is each object query, and reference sign d_{M} indicates a Mahalanobis distance in the query-embedded space.

In the learning step of the objectness determining unit 154, a sum of the square Mahalanobis distances expressed by Expression (2) is defined as an error function L_{obj} of objectness in order to estimate (optimize) the average value μ and the variance-covariance matrix Σ of the multivariable Gaussian distribution.

$${ℒ}_{obj} = {\sum }_{i ∈ Z} {{d}_{M} ( {q}_{i} )}^{2} \qquad ( 2 )$$

In Expression (2), reference sign Z indicates a set of queries qᵢ matched with known objects in the training data 140. By performing learning such that the error function L_{obj} is decreased (that is, the likelihood is optimized), p(o|q)=f_{obj}(q) indicating objectness of each object query is learned.

The object area detecting unit 155 (bbox head) detects a position of an object in the image IM as a bounding box for each object query output from the transformer decoder layer. More specifically, the object area detecting unit 155 is a deep neural network (DNN) outputting position information (central coordinates, a width, and a height) of a bounding box corresponding to an object query for each object query. The object area detecting unit 155 is obtained by reducing a L₁ loss and a generalized intersection over union (gIoU) loss L_{bb} for learning a bounding box.

The class detecting unit 156 (class head) probabilistically detects a class of an object (hereinafter an output value from the class detecting unit 156 may be referred to as p(c|o, q)) when it is assumed that each object query output from the transformer decoder layer is an object. More specifically, the class detecting unit 156 is a DNN outputting a class (type) of one object as a probability value when it is assumed that each object query is an object. The class detecting unit 156 is obtained by reducing a sigmoid focal loss L_{cls} for learning of class detection. The class detecting unit 156 is trained to output a class for each known object and is trained to output an unknown class for an unknown object.

In this way, the transformer decoder layers output N object queries, and the objectness determining unit 154, the object area detecting unit 155, and the class detecting unit 156 receive the object queries q as an input and outputs a probability value p(o|q), position information of a bounding box, and a probability value p(c|o, q). In the learning step of the machine learning model 150, learning is finally performed to decrease an error function L expressed by Expression (3) using the error function L_{obj} of the objectness determining unit 154, the error function L_{bb} of the object area detecting unit 155, and the error function L_{cls} of the class detecting unit 156.

L=L_{bb}+L_{cls}+L_{obj} (3)

As expressed by Expression (3), the error function L is expressed as a sum of the error function L_{obj}, the error function L_{bb}, and the error function L_{cls}. That is, in the learning step, objectness determination, bounding box determination, and class determination are simultaneously learned. However, the learning of objectness determination and the learning of class determination may compete. This is because the learning of objectness determination tends to separate feature quantities of an object from the background and to combine the feature quantities (and thus recognize a single object) and the learning of class determination tends to separate the feature quantities of objects and to separate the objects (and thus identify different objects).

In consideration of the aforementioned circumstances, in the present embodiment, the learning of objectness determination is stopped in the initial step (for example, a second layer) out of the transformer decoder layers, and only the learning of bounding box determination and the learning of class determination are performed in layers subsequent thereto. For example, in FIG. 3, the number of layers of the transformer decoder is 6, the layers including the first layer to the (n−1)-th layer (2<n<6) and the sixth layer are trained to decrease the error function L expressed by Expression (3), and the n-th to fifth layers are trained to decrease an error function L′=L_{bb}+L_{cls}. Accordingly, it is possible to train the objectness determining unit 154, the object area detecting unit 155 and the class detecting unit 156 while curbing competition between the learning of objectness determination and the learning of class determination. The number of layers of the transformer decoder which is 6 in FIG. 3 is merely an example and can set to an arbitrary positive integer.

### [Inference Using Machine Learning Model]

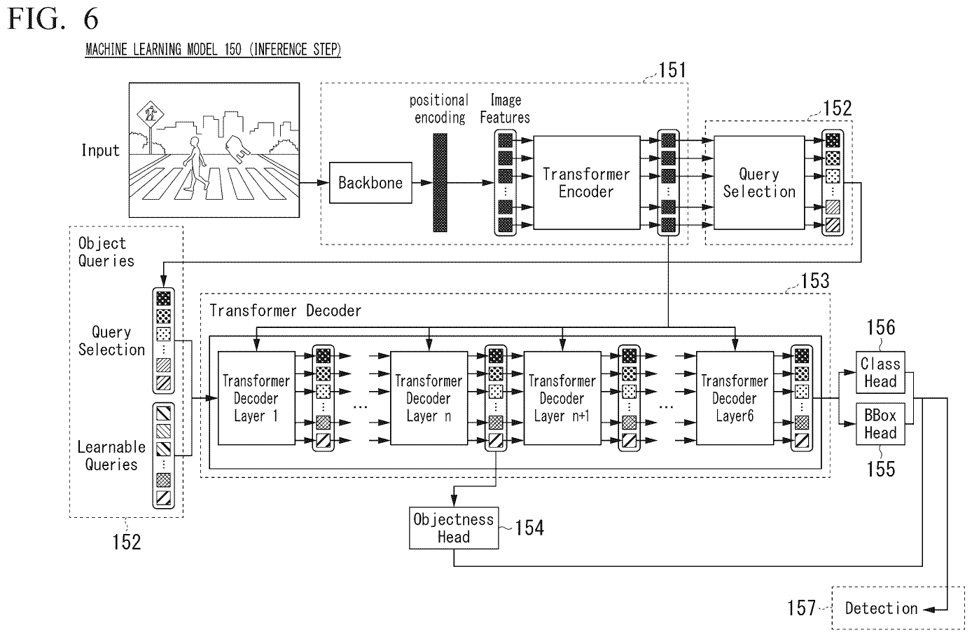

FIG. 6 is a diagram illustrating an example of a configuration of the machine learning model 150 in the inference step. The machine learning model 150 illustrated in FIG. 6 is a trained model obtained in the step in which the learning of the machine learning model 150 illustrated in FIG. 5 has been completed. The initialized learnable query in FIG. 5 is a learned query in FIG. 6. The machine learning model 150 in the inference step receives an image in which an object is to be estimated as an input and sequentially performs the processes of the high-dimensional vector conversion unit 151, the query generating unit 152, and the decoder unit 153.

As described above, the learning of objectness determination is stopped in the step of the initial layer out of the transformer decoder layers. Accordingly, in FIG. 6, the objectness determining unit 154 in the machine learning model 150 in the inference step receives an object query q in the n-th layer as an input and outputs an objectness probability value p(o|q). On the other hand, the object area detecting unit 155 receives an object query q in the sixth layer as an input and outputs position information of the bounding box. Similarly, the class detecting unit 156 receives the object query q in the sixth layer as an input and outputs a class probability value p(c|o, q).

In the inference step, the object detecting unit 157 detects an object from an input image to be estimated on the basis of the probability value p(o|q) output from the objectness determining unit 154, the position information of the bounding box output from the object area detecting unit 155, and the probability value p(c|o, q) output from the class detecting unit 156.

More specifically, the object detecting unit 157 first calculates an estimated value p(c|q)=p(c|o, q)×p(o|q) of a final class for each object query q. Then, the object detecting unit 157 narrows the object queries q to object queries in which the estimated value p(c|q) of the final class is equal to or greater than a threshold value and detects the narrowed object queries q as an object. Alternatively, the object detecting unit 157 may narrow the object queries to predetermined number of object queries q in which the estimated value p(c|q) of the final class is the highest.

When an object is detected by the object detecting unit 157, the object detection device 100 may provide information on the detected object to the vehicle M and be used to driving support or automated driving. For example, the object detection device 100 may overlap and display the class information and the position information of the bounding box for the object query q detected as an object on the input image and output the information to, for example, the navigation device of the vehicle M. The vehicle M having an automated driving function may generate a traveling trajectory such that the vehicle M avoids the object query q detected as an object.

### Advantageous Effects of Technique According to Present Invention

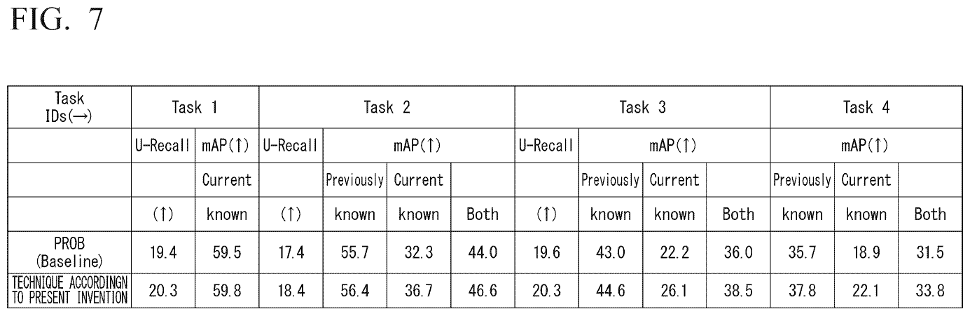

FIG. 7 is a diagram illustrating advantageous effects of the technique according to the present invention. In the table illustrated in FIG. 7, the upper part illustrates performance of object detection tasks TASK1 to TASK4 based on the technique described in Non Patent Document 1, and the lower part illustrates performance of the tasks based on the technique according to the present invention. As illustrated in FIG. 7, in each of the object detection tasks TASK1 to TASK4, it has been confirmed that performance of the technique according to the present invention is more improved in comparison with the technique described in Non Patent Document 1 in any of performance (mAP) of detecting a known object and performance (U-recall) of detecting an unknown object.

### [Process Flow]

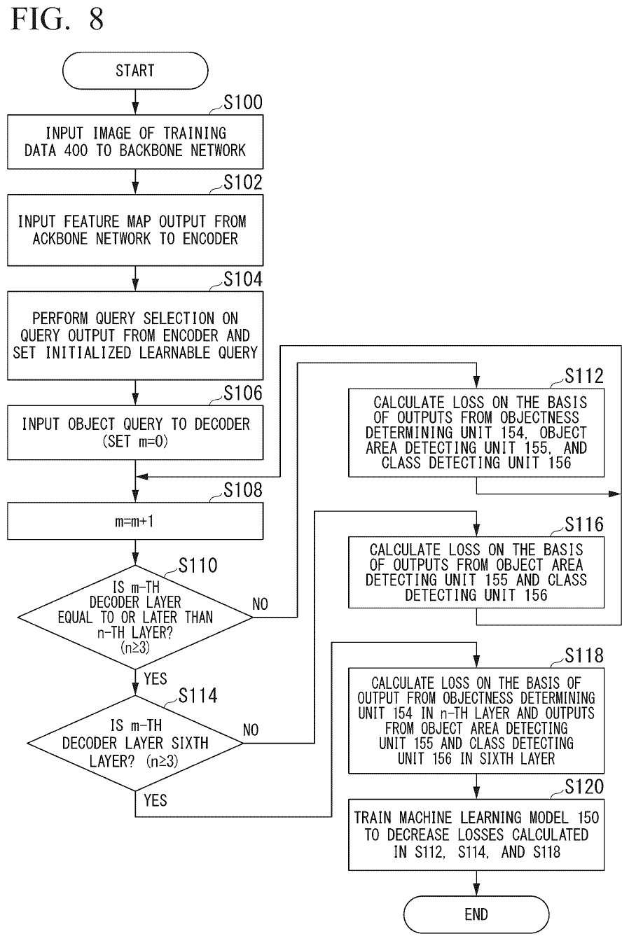

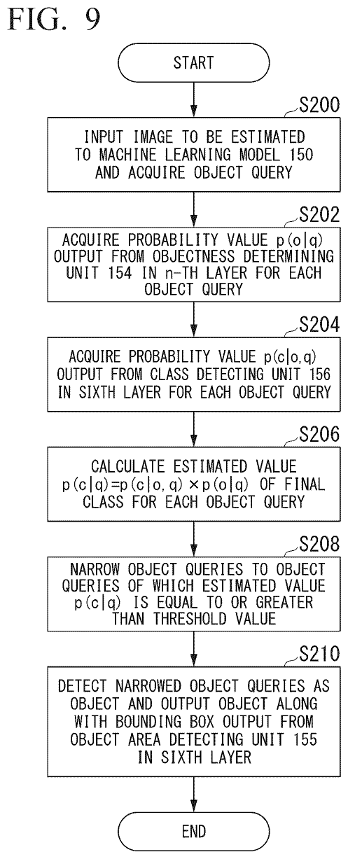

A process flow of learning and inference performed by the machine learning model 150 according to the present invention will be described below with reference to FIGS. 8 and 9. FIG. 8 is a flowchart illustrating an example of a process flow of learning performed by the machine learning model 150. The processes in the flowchart illustrated in FIG. 8 may be manually performed or may be automatically performed by a “learning device” which is a computer device in which the processes of the flowchart are mounted.

First, images of the training data 400 are input to the backbone network of the machine learning model 150 (Step S100). Then, a feature map output from the backbone network is input to an encoder (a transformer encoder) (Step S102). Then, query selection is performed on queries output from the encoder, and initialized learnable queries are set as object queries (Step S104). Then, the set object queries are input to a decoder (m=0 is simultaneously set) (Step S106).

Then, m=m+1 is set (Step S108). Then, it is determined whether the m-th decoder layer is equal to or later than the n-th layer (for example, n≥3) (Step S110). When it is determined that the m-th decoder layer is earlier than the n-th layer, a loss L=L_{obj}+L_{bb}+L_{cls} is calculated on the basis of the outputs from the objectness determining unit 154, the object area detecting unit 155, and the class detecting unit 156 (Step S112). On the other hand, when it is determined that the m-th decoder layer is equal to or later than the n-th layer, it is then determined whether the m-th decoder layer is the sixth layer (Step S114).

When it is determined that the m-th decoder layer is not the sixth layer, a loss L′=L_{bb}+L_{cls} is calculated on the basis of the outputs from the object area detecting unit 155 and the class detecting unit 156 (Step S116). On the other hand, when it is determined that the m-th decoder layer is the sixth layer, the loss L=L_{obj}+L_{bb}+L_{cls} is calculated on the basis of the output from the objectness determining unit 154 in the n-th layer and the outputs from the object area detecting unit 155 and the class detecting unit 156 in the sixth layer (Step S118). Then, the machine learning model 150 is trained to decrease the losses calculated in Steps S112, S114, and S118 (Step S120). Accordingly, the process flow of the flowchart ends.

FIG. 9 is a flowchart illustrating an example of a process flow of inference performed by the machine learning model 150. The machine learning model 150 in FIG. 9 is a trained model in which learning based on the flowchart illustrated in FIG. 8 has been completed and which is used by the object detection device 100.

First, the object detection device 100 inputs an image to be estimated to the machine learning model 150 and acquires object queries (Step S200). Then, the object detection device 100 acquires a probability value p(o|q) output from the objectness determining unit 154 in the n-th layer for each object query (Step S202). Then, the object detection device 100 acquires a probability value p(c|o, q) output from the class detecting unit 156 in the sixth layer for each object query (Step S204).

Then, the object detection device 100 calculates an estimated value p(c|q)=p(c|o, q)×p(o|q) of the final class for each object query using the object detecting unit 157 (Step S206). Then, the object detection device 100 narrows the object queries to object queries in which the estimated value p(c|q) is equal to or greater than a threshold value using the object detecting unit 157 (Step S208). Then, the object detection device 100 detects the narrowed object queries as an object and outputs the object along with bounding box information output from the object area detecting unit 155 in the sixth layer (Step S210). Accordingly, the process flow in the flowchart ends.

In the aforementioned embodiment, the high-dimensional vector conversion unit 151, the query generating unit 152, the decoder unit 153, the objectness determining unit 154, the object area detecting unit 155, the class detecting unit 156, and the object detecting unit 157 are described as the constituents of the machine learning model 150, but these constituents are for the purpose of convenience of explanation, and the present invention is not particularly limited thereto as long as the learning of objectness estimation is stopped early on the basis of the DETR technique and the initialized learnable queries are added to the object queries.

According to the present embodiment described above, in object detection of both a known object and an unknown object, the learning of objectness estimation is stopped in the step of the initial layer of the transformer decoder, only the learning of class estimation and the learning of object area detection are performed in subsequent layers, and the object queries include queries selected through query selection to ascertain known objects and initialized learnable queries to ascertain both a known object and an unknown object. That is, as a result, it is possible to enhance object detection accuracy by preventing competition between the learning of objectness estimation and the learning of class estimation and enabling ascertaining features of an object from the initial layer of the transformer decoder.

The aforementioned embodiment can be expressed as follows:

A driving support device including:
a storage medium configured to store computer-readable instructions; and
a processor connected to the storage medium,
wherein the processor executes the computer-readable instructions to perform:
   converting an input image to a high-dimensional vector;
   determining whether a query set in the input image is an object on the basis of the high-dimensional vector;
   detecting an area of the object on the basis of the high-dimensional vector;
   detecting a type of the object on the basis of the high-dimensional vector; and
   detecting an object by processing the high-dimensional vector,
wherein the query includes a first query selected from a plurality of the high-dimensional vectors and an initialized second query, and
wherein the processor detects the object by processing the high-dimensional vector on the basis of the first query and the second query.

While exemplary embodiments of the present invention have been described above, the present invention is not limited to the embodiments and can have various modifications and substitutions applied thereto without departing from the gist of the present invention.

What is claimed is:

1. An object detection device comprising:
a storage medium configured to store computer-readable instructions; and
a processor connected to the storage medium,
wherein the processor executes the computer-readable instructions to perform:
converting an input image to a high-dimensional vector;
determining whether a query set in the input image is an object on the basis of the high-dimensional vector;
detecting an area of the object on the basis of the high-dimensional vector;
detecting a type of the object on the basis of the high-dimensional vector; and
detecting an object by processing the high-dimensional vector,
wherein the query includes a first query selected from a plurality of the high-dimensional vectors and an initialized second query, and
wherein the processor detects the object by processing the high-dimensional vector on the basis of the first query and the second query.

2. The object detection device according to claim 1, wherein the first query is selected to be distributed to known objects in the input image, and the second query is set to be distributed to the whole input image and is learned to be distributed to known objects and unknown objects.

3. The object detection device according to claim 1, wherein the processor detects the object on the basis of the detection results of the area and the type based on the high-dimensional vector obtained by processing the high-dimensional vector a plurality of times and the determination results based on the high-dimensional vector obtained by processing the high-dimensional vectors before the plurality of times.

4. The object detection device according to claim 1, wherein functional units for the conversion of the high-dimensional vector, the determination, the detection of the area, and the detection of the type are obtained by training a deep learning model including a self-attention mechanism.

5. The object detection device according to claim 4, wherein the deep learning model is a transformer model, and
wherein the processor detects the object on the basis of the detection results of the area and the type based on the high-dimensional vector obtained by processing the high-dimensional vector a plurality of times in layers of a decoder of the transformer model and the determination results based on the high-dimensional vector obtained by processing the high-dimensional vector before the plurality of times in the layers of the decoder.

6. The object detection device according to claim 1, wherein the processor calculates whether the query is an object as a first probability value,
wherein the processor calculates the type of the query as a second probability value, and
wherein the processor detects the object on the basis of the first probability value and the second probability value.

7. An object detection method that is performed by a computer, the object detection method comprising:
converting an input image to a high-dimensional vector;
determining whether a query set in the input image is an object on the basis of the high-dimensional vector;
detecting an area of the object on the basis of the high-dimensional vector;
detecting a type of the object on the basis of the high-dimensional vector; and
detecting an object by processing the high-dimensional vector,
wherein the query includes a first query selected from a plurality of the high-dimensional vectors and an initialized second query, and
wherein the object is detected by processing the high-dimensional vector on the basis of the first query and the second query.

8. A non-transitory computer-readable storage medium storing a program causing a computer to perform:
converting an input image to a high-dimensional vector;
determining whether a query set in the input image is an object on the basis of the high-dimensional vector;
detecting an area of the object on the basis of the high-dimensional vector;
detecting a type of the object on the basis of the high-dimensional vector; and
detecting an object by processing the high-dimensional vector,
wherein the query includes a first query selected from a plurality of the high-dimensional vectors and an initialized second query, and
wherein the object is detected by processing the high-dimensional vector on the basis of the first query and the second query.
